(19) United States
(12) Patent Application Publication
(10) Pub. No.: US 2012/0287366 A1
(43) Pub. Date: Nov. 15, 2012

(54) METHOD FOR CORRECTING DEFECT IN DISPLAY DEVICE, DISPLAY DEVICE AND METHOD FOR MANUFACTURING DISPLAY DEVICE

(75) Inventor: Naoyuki Tanaka, Osaka-shi (JP)

(73) Assignee: SHARP KABUSHIKI KAISHA, Osaka-shi, Osaka (JP)

(21) Appl. No.: 13/522,794

(22) PCT Filed: Dec. 29, 2010
(86) PCT No.: PCT/JP2010/073824

§ 371 Date: Jul. 18, 2012

(30) Foreign Application Priority Data
Jan. 28, 2010 (JP) 2010-016592

(51) Int. Cl. H01J 9/50; G02F 1/1333

(52) U.S. Cl. 349/54; 445/2

(57) ABSTRACT

There is provided a method for correcting a defect of a first wiring of a plurality of wirings in a display device, the display device including: a plurality of wirings extending in parallel to one another in a same layer in one gap region sandwiched between two adjacent picture element electrodes; and an upper insulating layer provided to cover the plurality of wirings, the method including the steps of: boring a first through hole and a second through hole in the upper insulating layer in a first portion and a second portion located to sandwich a break area that is the defect, respectively; and forming a repairing conductive film so as to electrically connect a portion of the first wiring exposed in the first through hole and a portion of the first wiring exposed in the second through hole.

### TECHNICAL FIELD

The present invention relates to a method for correcting a defect in a display device, a display device and a method for manufacturing the display device. The display device includes, for example, a liquid crystal display device.

### BACKGROUND ART

A liquid crystal display device, which is one type of display device, is provided with many wirings on a glass substrate. As defects occurring at these wirings on the substrate, there are basically two types, i.e., break and short circuit, and various methods for correcting these defects have been conventionally researched and developed. One example thereof is described in International Publication WO2008/026352 (PTL 1).

On the other hand, a so-called pixel dividing structure has been under study in the liquid crystal display device in order to enhance the driving speed and improve the display performance such as improvement in viewing angle. “Pixel dividing structure” herein refers to a structure capable of dividing one pixel into two sub-pixels and driving the respective sub-pixels independently. One example thereof is described in Japanese Patent Laying-Open No. 2004-62146 (PTL 2). In this structure, two source lines, i.e., signal lines are used. As shown in FIG. 25, for example, two signal lines 1 and 2, not one signal line, are disposed in one gap region 10 sandwiched between two adjacent picture element electrodes 31a and 31b of a plurality of picture element electrodes arranged in a plane on a substrate. In FIG. 25, structures such as TFT (Thin Film Transistor) are not shown. Although the picture element electrode does not actually have a simple rectangular shape, the picture element electrode is shown to have a rectangular shape for convenience of description. Two signal lines 1 and 2 in one gap region 10 are usually disposed in parallel to each other in the same layer.

In addition, as shown in FIG. 26, three or more wirings including not only the two signal lines but also wirings for other purposes may be disposed in parallel to one another in the same layer in one gap region. In the example shown in FIG. 26, wirings 11, 12, 13, and 14 are disposed in one gap region 10j.

### CITATION LIST

### Patent Literature

PTL 1: International Publication WO2008/026352
PTL 2: Japanese Patent Laying-Open No. 2004-62146

### SUMMARY OF INVENTION

### Technical Problem

In the aforementioned pixel dividing structure and the like, the plurality of wirings are arranged in parallel to one another in one gap region. In implementing the display device, it is desired to secure an area occupied by the picture element electrodes in a display region as large as possible. Therefore, it is desired to minimize the width of the gap region created between the picture element electrodes. As a result, the plurality of wirings are densely arranged in one gap region. However, the uses of the plurality of these wirings are different, and thus, a short circuit between the wirings must be avoided. In some conventionally known repairing methods, when one of the plurality of wirings in one gap region has a defect, there have been produced adverse effects such as generation of an undesirable leak current between the wiring and the other neighboring wirings to repair the defect.

Thus, an object of the present invention is to provide a method for correcting a defect in a display device, a display device and a method for manufacturing the display device, which can repair a defect of a wiring without adversely affecting the other neighboring wirings.

### Solution To Problem

In order to achieve the aforementioned object, a method for correcting a defect in a display device based on the present invention is directed to a method for correcting a defect of a first wiring of a plurality of wirings in a display device, the display device including: a substrate having a plurality of picture element electrodes arranged in a plane; a plurality of wirings extending in parallel to one another in a same layer in one gap region sandwiched between two adjacent picture element electrodes of the plurality of picture element electrodes; and an upper insulating layer provided to cover the plurality of wirings, the method including the steps of: boring a first through hole and a second through hole in the upper insulating layer so as to expose the first wiring in a first portion and a second portion located to sandwich an area of the defect of the first wiring, respectively; and forming, by laser CVD processing, a repairing conductive film integrally covering the first portion and the second portion, so as to electrically connect a portion of the first wiring exposed in the first through hole and a portion of the first wiring exposed in the second through hole.

In order to achieve the aforementioned object, a display device based on the present invention is directed to a display device, including: a substrate having a plurality of picture element electrodes arranged in a plane; a plurality of wirings extending in parallel to one another in a same layer in one gap region sandwiched between two adjacent picture element electrodes of the plurality of picture element electrodes; and an upper insulating layer provided to cover the plurality of wirings, a first through hole and a second through hole being bored in the upper insulating layer so as to expose a first wiring in a first portion and a second portion of the first wiring of the plurality of wirings, respectively, the display device further including a repairing conductive film provided by laser CVD processing to integrally cover the first through hole and the second through hole, so as to electrically connect a portion of the first wiring exposed in the first through hole and a portion of the first wiring exposed in the second through hole.

### Advantageous Effects of Invention

According to the method for correcting a defect in a display device based on the present invention, the repairing conductive film forms a bridge, and thus, the defect can be corrected. In addition to this, since this correction operation is performed after the upper insulating layer is formed to cover the layers of the wirings, the wirings other than the wiring relating to the defect are protected by the upper insulating layer. Therefore, occurrence of a new short circuit between the wirings and the repairing conductive film is prevented.

According to the display device based on the present invention, even when a break area is present as the defect somewhere in the wiring, an influence of this defect can be eliminated because an electrical path is secured by the repairing conductive film. The highly reliable display device with a few defects can thus be obtained.

### BRIEF DESCRIPTION OF DRAWINGS

FIG. 1 is a flowchart of a method for correcting a defect in a display device according to a first embodiment of the present invention.

FIG. 2 is a plan view of a region near a break area of a wiring in the display device.

FIG. 3 is a cross-sectional view taken along line III-III in FIG. 2.

FIG. 4 is a cross-sectional view of a state after step S1 of the method for correcting a defect in a display device according to the first embodiment of the present invention.

FIG. 5 is a plan view of a state after step S2 of the method for correcting a defect in a display device according to the first embodiment of the present invention.

FIG. 6 is a cross-sectional view taken along line VI-VI in FIG. 5.

FIG. 7 is a flowchart of a method for correcting a defect in a display device according to a second embodiment of the present invention.

FIG. 8 is a plan view of a region near a short circuit portion of a wiring in the display device.

FIG. 9 is a cross-sectional view taken along line IX-IX in FIG. 8.

FIG. 10 is a plan view of a state after step S2 of the method for correcting a defect in a display device according to the second embodiment of the present invention.

FIG. 11 is a cross-sectional view taken along line XI-XI in FIG. 10.

FIG. 12 is a plan view of a state after step S3 of the method for correcting a defect in a display device according to the second embodiment of the present invention.

FIG. 13 is a cross-sectional view taken along line XIII-XIII in FIG. 12.

FIG. 14 is a plan view of an example in which two or more wirings are disposed in one gap region.

FIG. 15 is a plan view of a state after step S2 when two or more wirings are disposed in one gap region.

FIG. 16 is a plan view of a state after step S3 when two or more wirings are disposed in one gap region.

FIG. 17 is a cross-sectional view taken along line XVII-XVII in FIG. 16.

FIG. 18 is a cross-sectional view of a state in which a further protective insulating layer is provided after step S3.

FIG. 19 is a plan view of a state after step S2 of a method for correcting a defect in a display device according to a third embodiment of the present invention.

FIG. 20 is a plan view of a state after step S4 of the method for correcting a defect in a display device according to the third embodiment of the present invention.

FIG. 21 is a first explanatory view of an example in which the method for correcting a defect in a display device according to the third embodiment of the present invention is applied to breaks occurring at a plurality of wirings simultaneously.

FIG. 22 is a second explanatory view of the example in which the method for correcting a defect in a display device according to the third embodiment of the present invention is applied to breaks occurring at a plurality of wirings simultaneously.

FIG. 23 is a third explanatory view of the example in which the method for correcting a defect in a display device according to the third embodiment of the present invention is applied to breaks occurring at a plurality of wirings simultaneously.

FIG. 24 is a flowchart of a method for manufacturing a display device according to a fourth embodiment of the present invention.

FIG. 25 is a plan view of a part of a first example of a display device based on the conventional art.

FIG. 26 is a plan view of a part of a second example of the display device based on the conventional art.

### DESCRIPTION OF EMBODIMENTS

### First Embodiment

(Method For Correcting Defect In Display Device)

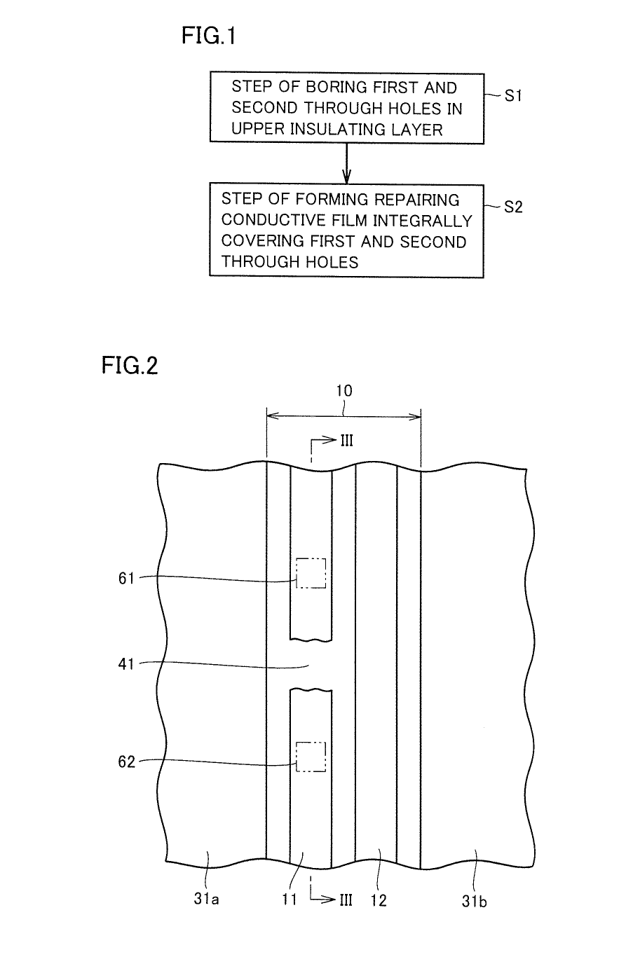

A method for correcting a defect in a display device according to a first embodiment of the present invention will be described with reference to FIGS. 1 to 6. FIG. 1 shows a flowchart of this method for correcting a defect in a display device. The method for correcting a defect in a display device is directed to a method for correcting a defect of a first wiring of a plurality of wirings in a display device, the display device including: a substrate having a plurality of picture element electrodes arranged in a plane; a plurality of wirings extending in parallel to one another in a same layer in one gap region sandwiched between two adjacent picture element electrodes of the plurality of picture element electrodes; and an upper insulating layer provided to cover the plurality of wirings, the method including: step S1 of boring a first through hole and a second through hole in the upper insulating layer so as to expose the first wiring in a first portion and a second portion located to sandwich an area of the defect of the first wiring, respectively; and step S2 of forming a repairing conductive film integrally covering the first portion and the second portion, so as to electrically connect a portion of the first wiring exposed in the first through hole and a portion of the first wiring exposed in the second through hole. Detailed description will be given below.

FIG. 2 shows a positional relationship between the picture element electrodes and the wirings on the substrate of the display device in a plan view. A plurality of picture element electrodes 31a and 31b are arranged on the substrate. A plurality of wirings 11 and 12 extend in parallel to each other in the same layer in one gap region 10 sandwiched between two adjacent picture element electrodes 31a and 31b. A part or all of wirings 11 and 12 may be source wirings (also referred to as “signal line”), or may be a wiring for an other purpose.

The defect assumed in the present embodiment is a break as shown in FIG. 2.

In FIG. 2, a break area 41 is actually present in wiring 11. The present invention may, however, be applied not only when the break area is actually present but also when the break is suspected. “First wiring” refers to a wiring in which a defect is actually present or a defect is suspected, and wiring 11 corresponds to the first wiring in the present embodiment. Any of the plurality of wirings may be the first wiring.

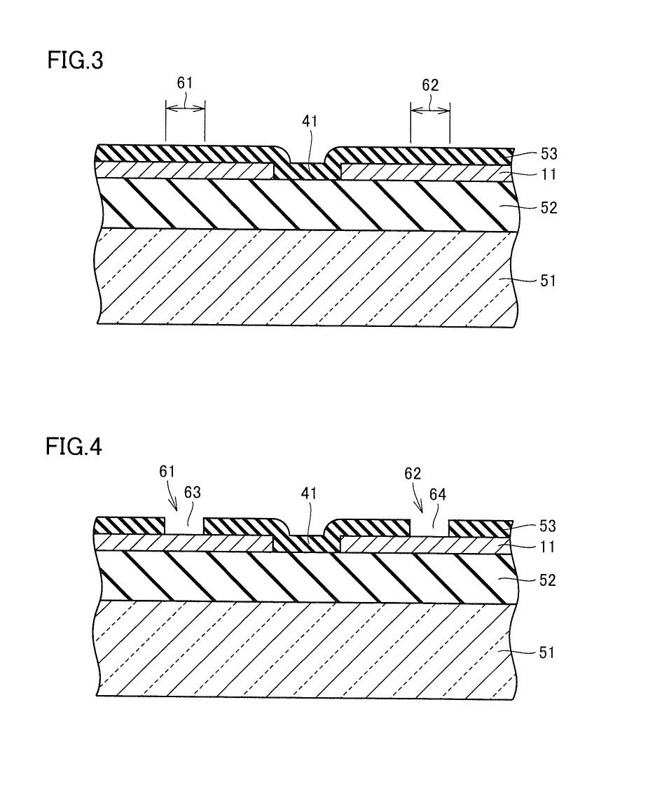

FIG. 3 shows a cross-sectional view taken along line III-III in FIG. 2. A lower insulating layer 52 is formed on the upper side of a substrate 51. Wiring 11 is formed on the upper side of lower insulating layer 52. An upper insulating layer 53 is formed on the upper side of wiring 11. Upper insulating layer 53 may be a single film, or may be an aggregate of a plurality of insulating films. The same is applied as well to lower insulating layer 52. Upper insulating layer 53 covers the overall region shown in FIG. 2.

Under this situation, step S1 is first performed to correct the defect in the method for correcting a defect according to the present embodiment. As step S1, first and second through holes 63 and 64 are bored in upper insulating layer 53 so as to expose wiring 11 in first and second portions 61 and 62 located to sandwich an area of the defect, i.e., break area 41 of wiring 11, which is the first wiring, of the plurality of wirings, respectively, as shown in FIG. 4. The operation of boring first and second through holes 63 and 64 can be performed by irradiation with laser light.

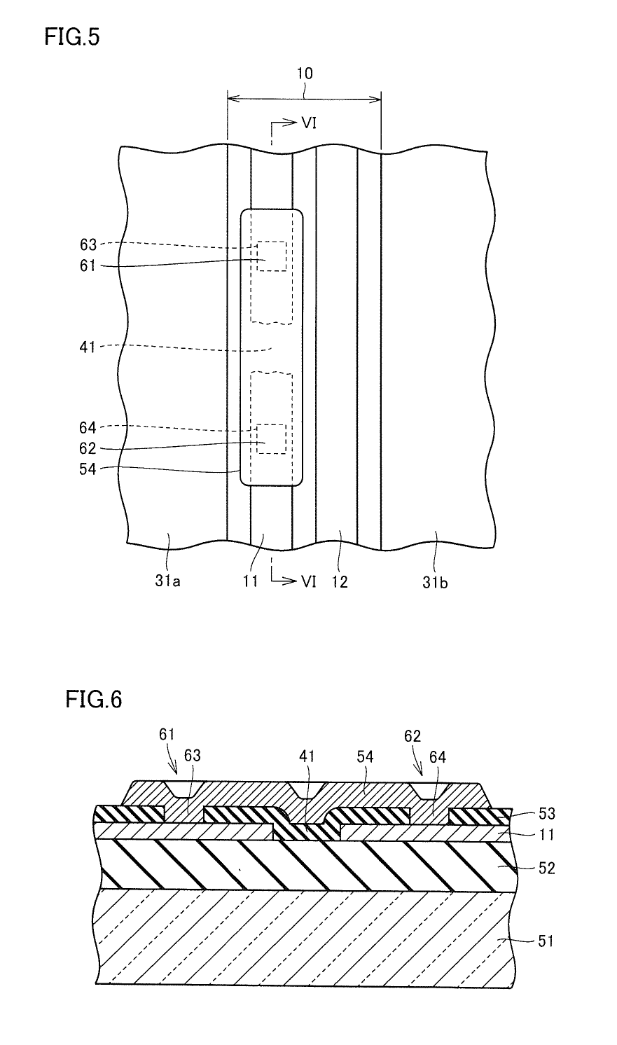

Next, as step S2, a repairing conductive film 54 integrally covering first portion 61 and second portion 62 is formed by laser CVD processing so as to electrically connect a portion of wiring 11 exposed in first through hole 63 and a portion of wiring 11 exposed in second through hole 64. FIG. 6 is a cross-sectional view taken along line VI-VI in FIG. 5. Repairing conductive film 54 is made of a material including at least one of, for example, aluminum, tungsten, copper, chromium, and molybdenum. Repairing conductive film 54 is formed to have a film thickness of for example, about 0.4 μm. When an attempt is made to form repairing conductive film 54 by laser CVD processing and by using, for example, tungsten as a main material, repairing conductive film 54 is formed by decomposing W(CO)6 molecules with laser light and forming a tungsten thin film on upper insulating layer 53 as well as wiring 11 exposed in first and second through holes 63 and 64. Although formation of the repairing conductive film in step S2 is implemented by laser CVD processing, the repairing conductive film may be formed by other known techniques. Laser CVD processing is one example of preferable methods.

A further insulating layer (not shown) may also be formed to protect the repairing conductive film.

In the present embodiment, the repairing conductive film formed on the upper side of the upper insulating layer electrically connects the portions of the wiring sandwiching the defect with respect to the defect of the wiring, and thus, the repairing conductive film forms a bridge so as to bypass the defect area. Therefore, when the type of the defect is a break, this defect can be corrected. Since this correction operation is performed after the upper insulating layer is formed to cover the layers of the wirings, the wirings other than the first wiring relating to the defect are protected by the upper insulating layer. Therefore, even when the repairing conductive film is firmed to reach the upper side of the wirings other than the first wiring, occurrence of a short circuit between the wirings other than the first wiring and the repairing conductive film is prevented.

The first wiring preferably has at least one break area between first portion 61 and second portion 62. When the break area is actually present, the effects of this method for correcting a defect can be actually enjoyed. “At least one break area” means that two or more break areas may be present between first portion 61 and second portion 62. In this case, the bridge of repairing conductive film 54 is formed to bypass the two or more break areas collectively. In this case, the plurality of break areas can be collectively corrected by one repairing conductive film 54.

Step S1 of boring first and second through holes 63 and 64 is preferably performed by irradiating first and second portions 61 and 62 with laser light. This is because the laser light allows boring of the through holes while precisely controlling the position.

Repairing conductive film 54 is preferably provided to have an elongated shape connecting first through hole 63 and second through hole 64 along the first wiring. Although repairing conductive film 54 is formed in the shape of a line segment directly connecting first through hole 63 and second through hole 64 in FIG. 5, repairing conductive film 54 does not always need to have the shape of such a line segment. Repairing conductive film 54 may be formed to cover a wider range. However, when repairing conductive film 54 is provided to have an elongated shape connecting first through hole 63 and second through hole 64 along the first wiring, an amount of wasted repairing conductive film 54 can become small and the degree of adverse effects on the other wirings can be minimized.

### Second Embodiment

(Method For Correcting Defect In Display Device)

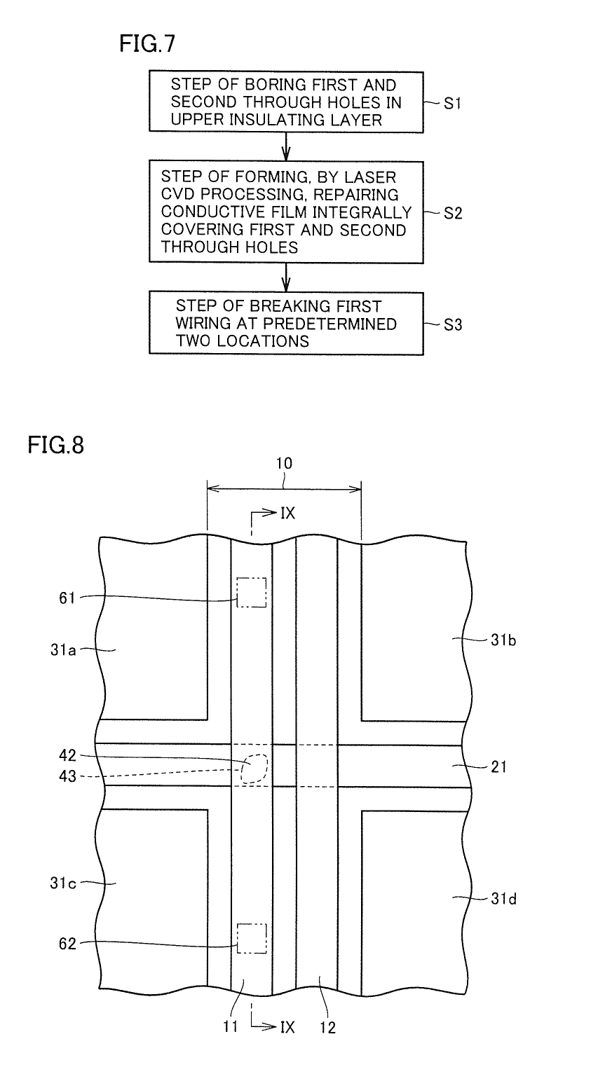

A method for correcting a defect in a display device according to a second embodiment of the present invention will be described with reference to FIGS. 7 to 13. FIG. 7 shows a flowchart of this method for correcting a defect in a display device. The method for correcting a defect in a display device according to the present embodiment basically includes steps S1 and S2 as described in the first embodiment. In the method for correcting a defect in a display device according to the present embodiment, however, there is a condition for disposition of the repairing conductive film in step S2, and the method further includes step S3 after step S2.

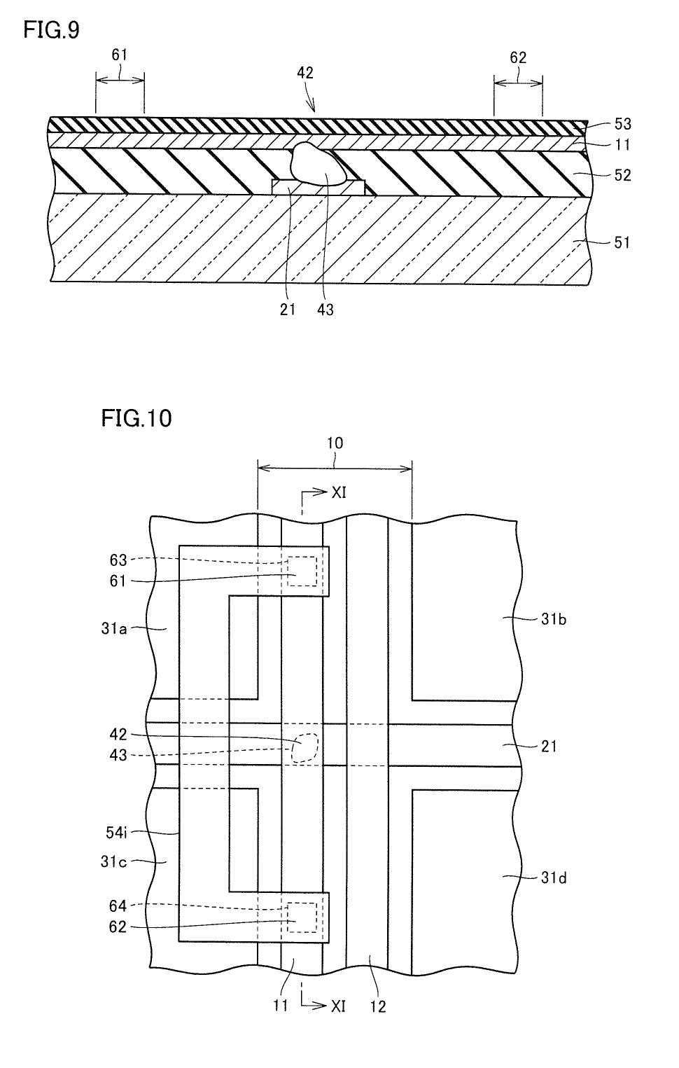

In the method for correcting a defect in a display device according to the present embodiment, between the first portion and the second portion, the first wiring has a short circuit portion electrically communicating with an other conductive portion, and in step S2 of forming the repairing conductive film, the repairing conductive film is formed to bypass the short circuit portion, and after step S2 of forming the repairing conductive film, the method includes step S3 of breaking the first wiring between the first portion and the short circuit portion as well as between the second portion and the short circuit portion. The definition of “first wiring” is the same as that described in the first embodiment. The short circuit is one type of defect. “Short circuit portion” refers to a portion where the first wiring is undesirably brought into conduction with any other conductive layer. FIG. 8 shows a portion where corner portions of arbitrary four picture element electrodes 31a, 31b, 31c, and 31d gather in the display device. FIG. 9 shows a cross-sectional view taken along line IX-IX in FIG. 8. As shown in FIGS. 8 and 9, in this example, a foreign substance 43 is included in a multilayer structure at a portion where wiring 11, which is the first wiring, and an other wiring 21 intersect with each other. As a result, wiring 11 and wiring 21, which should be electrically separated from each other basically, are electrically connected to each other. This portion will be called “short circuit portion” 42. For example, wiring 11 may be a source wiring and wiring 21 may be a gate wiring. This method for correcting a defect will be described below in more detail.

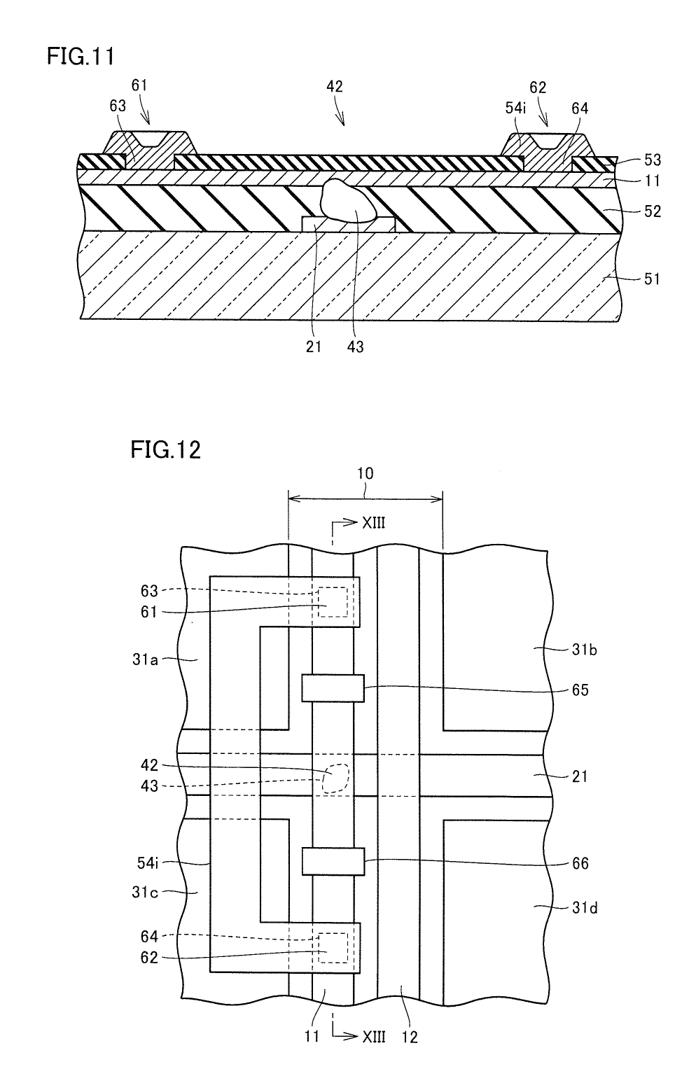

Forming the repairing conductive film as step S2 is in itself the same as that described in the first embodiment. However, the repairing conductive film in the present embodiment is not repairing conductive film 54 described in the first embodiment but a repairing conductive film 54i as shown in FIGS. 10 and 11. As shown in FIG. 9, repairing conductive film 54i is formed to bypass short circuit portion 42. FIG. 11 is a cross-sectional view taken along line XI-XI in FIG. 10. In FIG. 11, a cross section of repairing conductive film 54i is visible at first and second through holes 63 and 64, while repairing conductive film 54i is invisible at an intermediate portion connecting first through hole 63 and second through hole 64 because repairing conductive film 54i detours on the front side in the plane of sheet. Repairing conductive film 54i is preferably disposed so as not to pass above the picture element electrodes and the other wirings as much as possible. In the event of absolute necessity, however, repairing conductive film 54i may pass above, for example, picture element electrodes 31a and 31c as shown in FIG. 10. Since the upper side of the picture element electrodes is all covered with upper insulating layer 53 and repairing conductive film 54i is formed on the upper side of upper insulating layer 53, a short circuit does not occur between picture element electrodes 31a and 31c and repairing conductive film 54i even when repairing conductive film 54i overlaps with picture element electrodes 31a and 31c in the vertical direction.

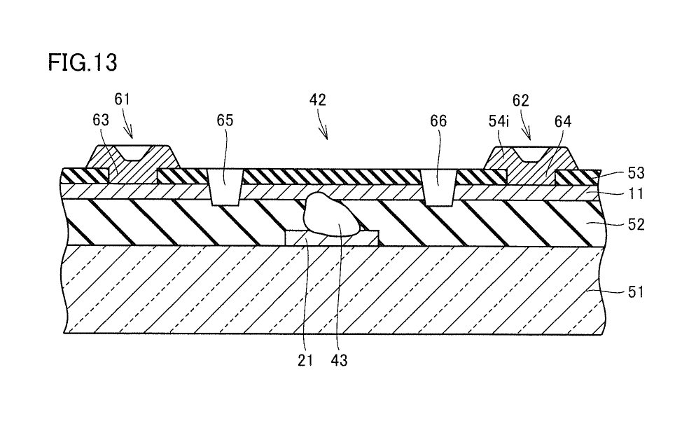

Step S3 is performed after step S2. Step S3 is a step of breaking wiring 11, which is the first wiring, between first portion 61 and short circuit portion 42 as well as between second portion 62 and short circuit portion 42 as shown in FIG. 12. Break portions 65 and 66 are formed by, for example, laser irradiation. FIG. 13 shows a cross-sectional view taken along line XIII-XIII in FIG. 12. As shown in FIG. 13, in break portions 65 and 66, a recess is formed to reach a position deeper than the lower surface of wiring 11.

In the present embodiment, the repairing conductive film formed on the upper side of the upper insulating layer electrically connects the first and second portions of the wiring sandwiching the defect with respect to the short circuit portion, which is the defect of the wiring, and the wiring is broken to sandwich the defect area inside the first and second portions. As a result, the wiring in a limited section including this defect can be electrically isolated, and the repairing conductive film forms a bridge so as to connect the wirings extending to both sides thereof. Therefore, even when the type of defect is a short circuit, an influence of the short circuit can be eliminated and conduction as the wiring can be secured. In other words, this defect can be corrected. Since this correction operation is performed after the upper insulating layer is formed to cover the layers of the wirings, the wirings other than the first wiring relating to the defect are protected by the upper insulating layer. Therefore, even when the repairing conductive film is thrmed to reach the upper side of the wirings other than the first wiring, occurrence of a short circuit between the wirings other than the first wiring and the repairing conductive film is prevented.

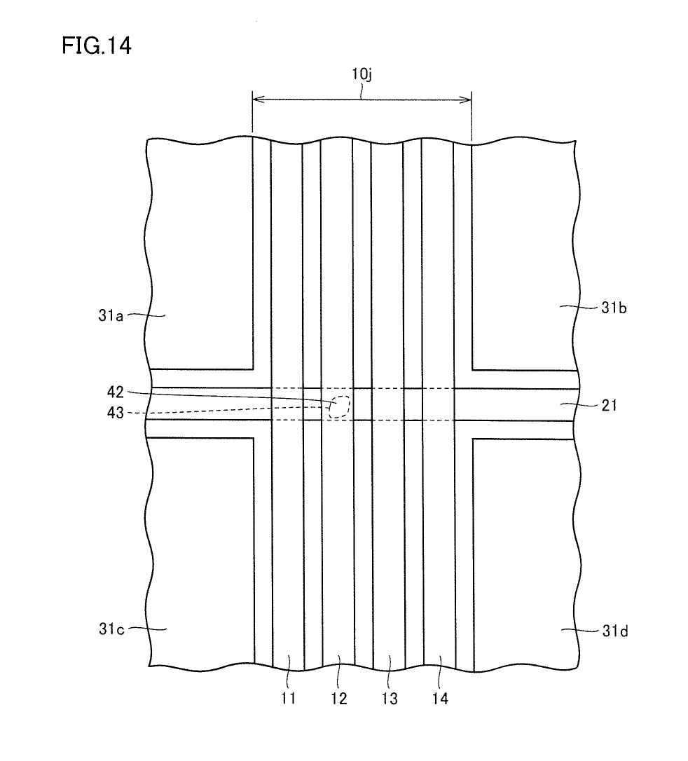

Although the example in which a total of two wirings are disposed in one gap region 10 has been described in the present embodiment, two or more wirings may be disposed in one gap region 10. As shown in FIG. 14, for example, four wirings 11, 12, 13, and 14 may be disposed in one gap region 10j. In this case, a wiring having a defect is not limited to a wiring at the end, and may be a wiring other than the wiring at the end as shown in FIG. 14. In FIG. 14, foreign substance 43 is included in wiring 12, and thereby short circuit portion 42 is created. In this example, wiring 12 corresponds to the first wiring.

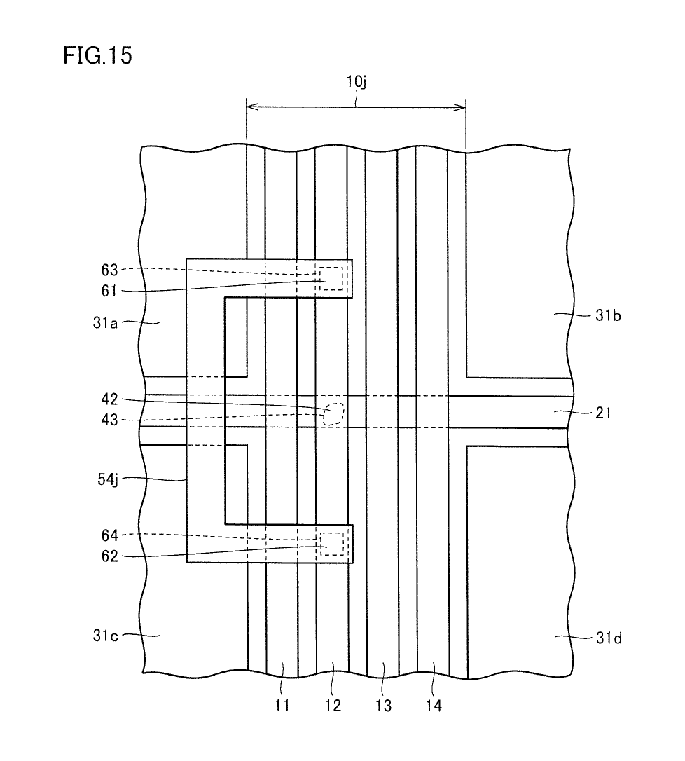

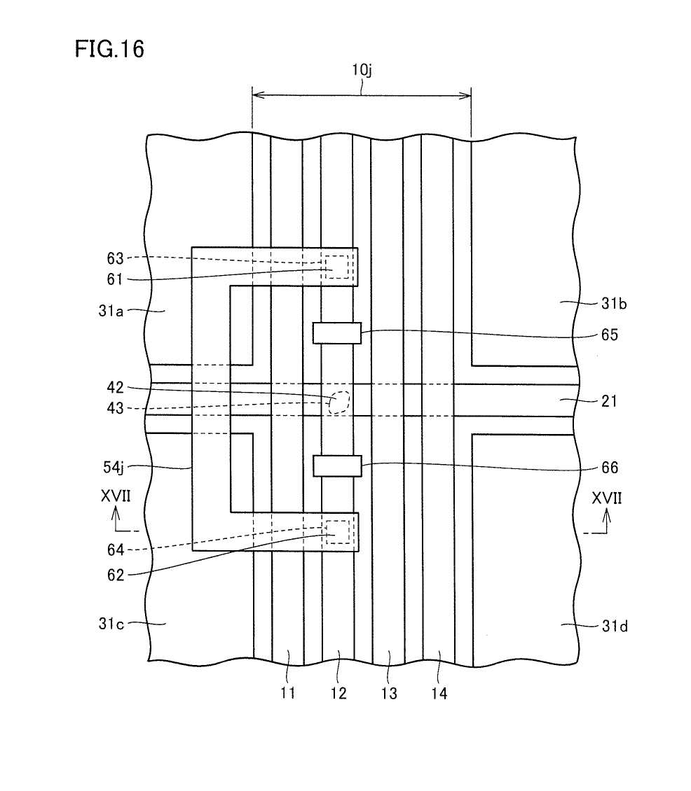

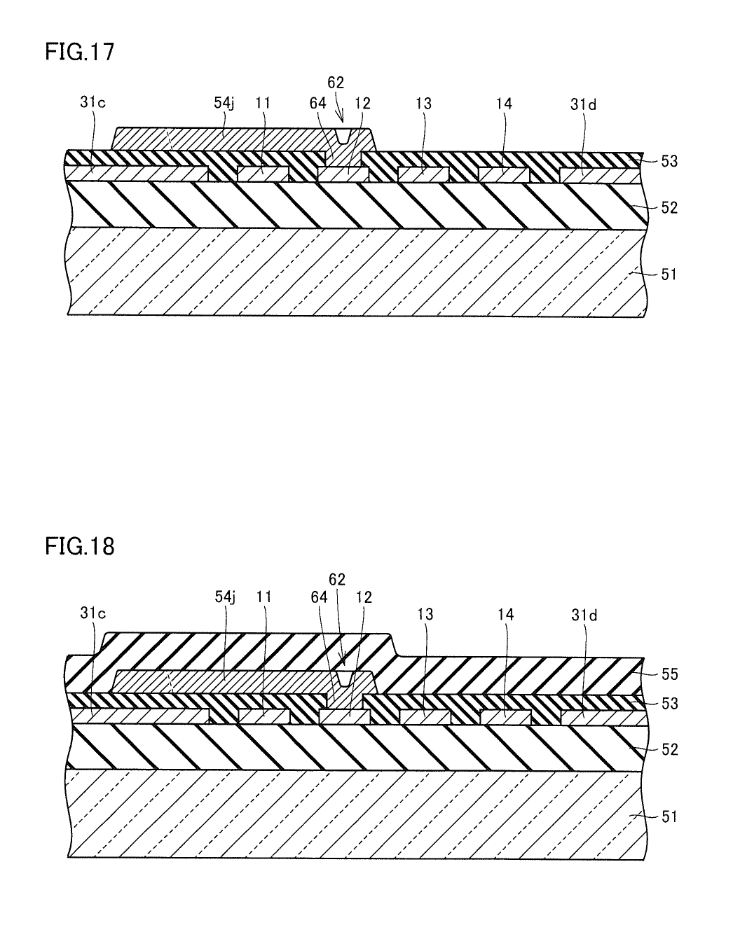

In this case, a repairing conductive film 54j may be formed as step S2 as shown in FIG. 15. Thereafter, break portions 65 and 66 may be formed as step S3 as shown in FIG. 16. FIG. 17 shows a cross-sectional view taken along line XVII-XVII in FIG. 16. FIG. 17 shows a manner in which repairing conductive film 54j is electrically connected to wiring 12 through second through hole 64 provided in second portion 62.

Since this correction operation is performed after the upper insulating layer is formed to cover the layers of the wirings, the wirings other than the wiring relating to the defect are protected by the upper insulating layer. Therefore, even when the repairing conductive film is formed to reach the upper side of the wirings other than the first wiring, occurrence of a short circuit between the wirings other than the first wiring and the repairing conductive film is prevented. However, in order to avoid problems such as parasitic capacitance, crosstalk and short circuit with more reliability, the repairing conductive film is preferably formed to detour on the side where the number of wirings is smaller as viewed from the first wiring. In the example shown in FIGS. 14 to 17, a total of two wirings, i.e., wirings 13 and 14 are present on the right side in the figures and a total of one wiring, i.e., wiring 11 is present on the left side in the figures, as viewed from wiring 12, which is the first wiring. Therefore, the repairing conductive film is formed to detour on the left side in the figures where the number of wirings is smaller.

The order of step S2 and step S3 may be reversed. In this case as well, the desired repairing conductive film can be formed. However, electrical connection again of the break portions previously formed in step S3 due to scattering of the conductive material when the repairing conductive film is formed in step S2 should be avoided. Therefore, step S2 is preferably performed before step S3.

An insulating layer may be formed to further cover the upper surface in the state shown in FIG. 17. As shown in FIG. 18, for example, a protective insulating layer 55 is formed. With this, repairing conductive film 54j is covered with protective insulating layer 55, and thus, occurrence of a short circuit between repairing conductive film 54j and the other wirings can be prevented. Therefore, formation of protective insulating layer 55 is preferable.

### Third Embodiment

(Method For Correcting Defect In Display Device)

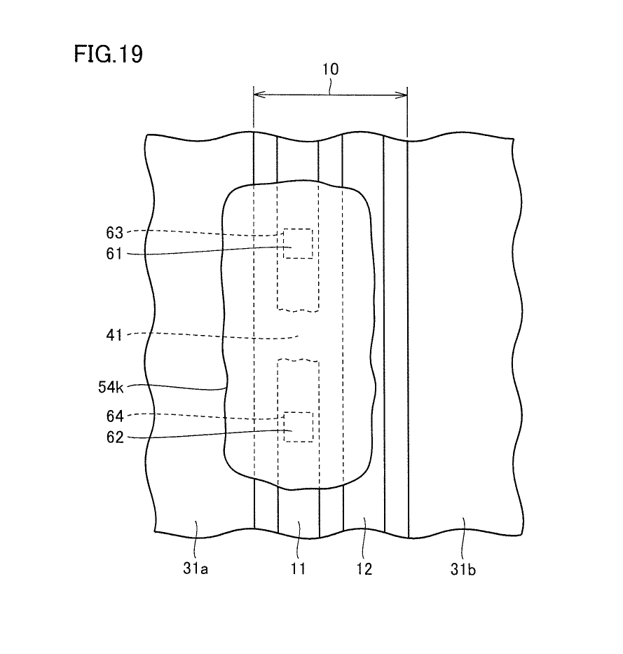

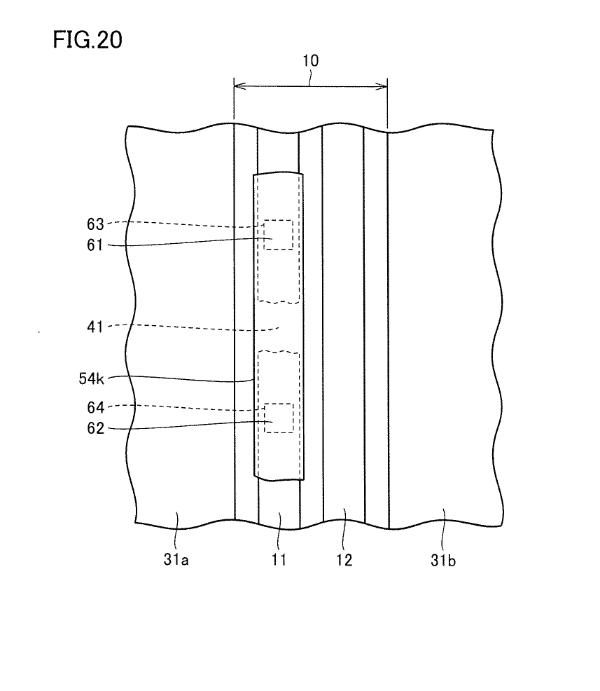

A method for correcting a defect in a display device according to a third embodiment of the present invention will be described with reference to FIGS. 19 and 20. The method for correcting a defect in a display device according to the present embodiment includes steps S1 and S2 as described in the first embodiment and further includes a step described below.

The method for correcting a defect in a display device according to the present embodiment includes step S4 of adjusting a planar outer shape of the repairing conductive film by removing an unnecessary portion of the repairing conductive film by irradiation with laser light, after step S2 of forming the repairing conductive film.

FIG. 19 shows one example of a state after step S2. Here, a repairing conductive film 54k formed in step S2 is formed over a wide range reaching the upper side of other wiring 12 and picture element electrode 31a. This state may be brought about when the accuracy of laser CVD processing is not sufficient or when a pitch of the wirings is extremely small.

As a result of irradiation with laser light as step S4, the state shown in FIG. 20 is obtained. Specifically, portions of repairing conductive film 54k protruding to right and left from the region above wiring 11 are removed. The planar outer shape of repairing conductive film 54k is thus adjusted.

In the present embodiment, the effects described in the first embodiment are obtained, and furthermore, the repairing conductive film can be formed only in a desired region even when the accuracy of laser CVD processing is not sufficient or even when a pitch of the wirings is extremely small, because the unnecessary portion of the repairing conductive film is removed. As a result, the problems such as parasitic capacitance, crosstalk and short circuit between the repairing conductive film and the other conductive films can be avoided with more reliability.

In the present embodiment, the unnecessary portion of the repairing conductive film is removed. However, repairing itself has already been accomplished even before the unnecessary portion of the repairing conductive film is removed. This is because the repairing conductive film rests on the upper insulating layer and is electrically isolated from the wirings other than the wiring to be connected. It is preferable, but not essential, to remove the unnecessary portion of the repairing conductive film after the repairing conductive film is formed.

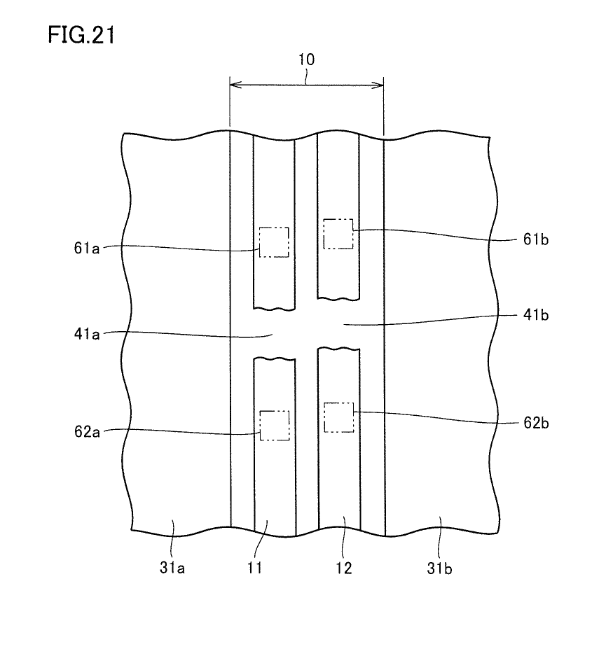

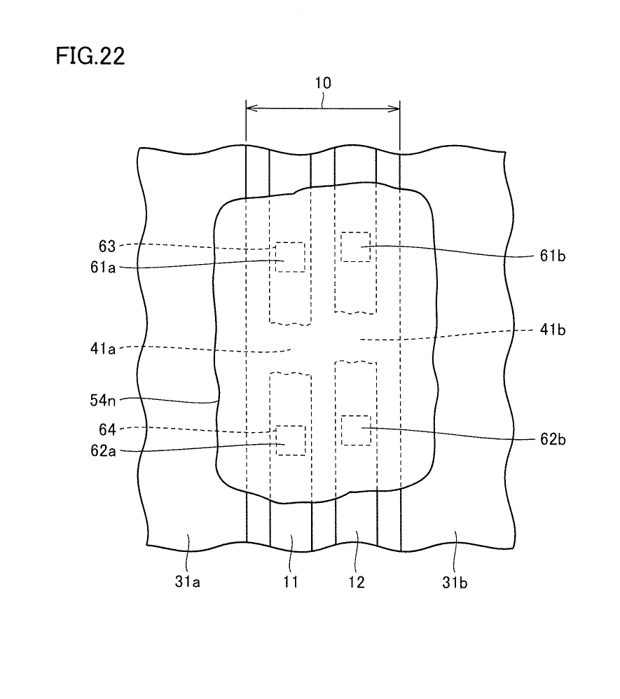

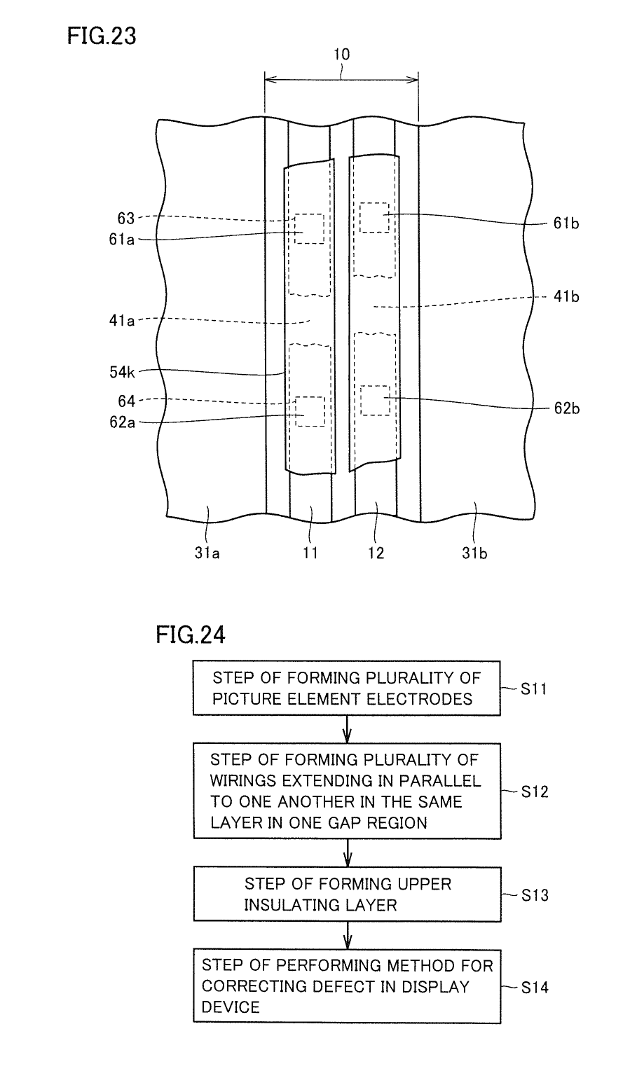

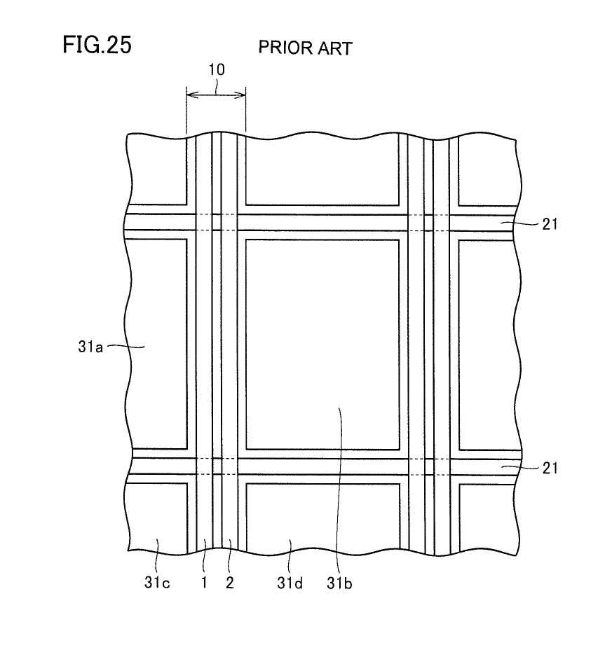

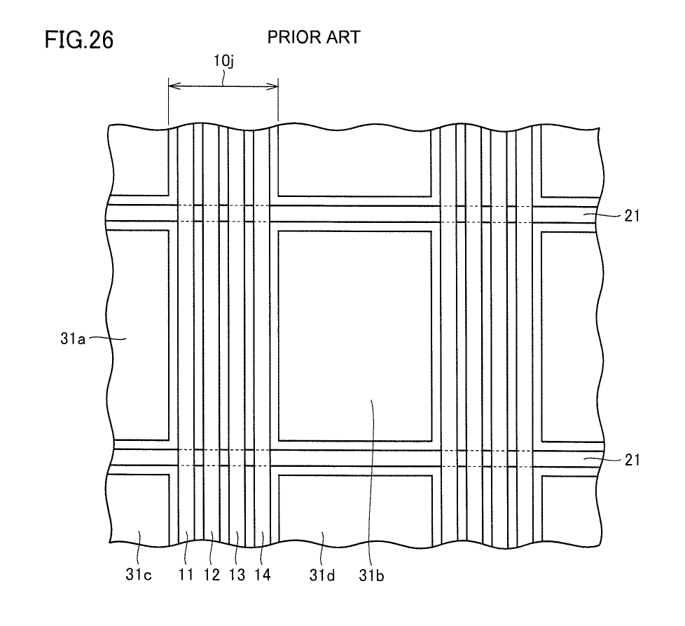

In the present embodiment, the case where two adjacent wirings 11 and 12 are both broken as shown in FIG. 21 can also be dealt with. In the example shown in FIG. 21, through holes are bored between first portions 61a, 61b and second portions 62a, 62b located to sandwich break areas 41a and 41b, respectively. Thereafter, a repairing conductive film 54n is formed by laser CVD processing as shown in FIG. 22. In this state, repairing conductive film 54n is formed to integrally cover two wirings 11 and 12. Then, an unnecessary portion of repairing conductive film 54n is removed by irradiation with laser light in step S4 and the planar outer shape is adjusted. As a result, the state shown in FIG. 23 is obtained. As described above, even when the repairing conductive film cannot be formed such that the respective wirings are differentiated and made electrically independent of one another at the time of formation of the repairing conductive film, the repairing conductive films that belong to the adjacent wirings can be separated by first roughly forming the repairing conductive film over a wide range, and then, removing the unnecessary portion in step S4. Therefore, precise repairing is possible even when an arrangement pitch of the wirings is narrow.

### Fourth Embodiment

(Method For Manufacturing Display Device)

A method for manufacturing a display device according to a fourth embodiment of the present invention will be described with reference to FIG. 24. FIG. 24 shows a flowchart of this method for manufacturing a display device. The method for manufacturing a display device according to the present embodiment includes: step S11 of forming, on a substrate, a plurality of picture element electrodes arranged in a plane; step S12 of forming a plurality of wirings extending in parallel to one another in a same layer in one gap region sandwiched between two adjacent picture element electrodes of the plurality of picture element electrodes; step S13 of forming an upper insulating layer to cover the plurality of wirings; and step S14 of performing, any one of the aforementioned methods for correcting a defect in a display device, Step S11 may be performed first, or step S12 may be performed first. When the picture element electrodes and the plurality of wirings are made of the same material in the same layer, step S11 and step S12 may be performed concurrently. The method for correcting a defect in a display device performed in step S14 may be any of the methods described in the first to third embodiments.

In the present embodiment, the plurality of wirings extending in parallel to one another in the same layer in one gap region sandwiched between two adjacent picture element electrodes are formed, and even when a defect occurs in any one of the plurality of these wirings, the defect can be smoothly repaired by performing step S14. Therefore, the efficiency of the operation of producing the display device can be increased, and furthermore, the number of products wasted as defective products can be reduced.

### Fifth Embodiment

(Display Device)

A display device according to a fifth embodiment of the present invention will be described.

As shown in FIGS. 5 and 6, the display device according to the present embodiment includes: substrate 51 having the plurality of picture element electrodes arranged in a plane; the plurality of wirings 11 and 12 extending in parallel to one another in the same layer in one gap region 10 sandwiched between two adjacent picture element electrodes 31a and 31b of the plurality of picture element electrodes; and upper insulating layer 53 provided to cover the plurality of wirings, first through hole 63 and second through hole 64 being bored in upper insulating layer 53 so as to expose the first wiring in first portion 61 and second portion 62 of wiring 11, which is the first wiring, of the plurality of wirings, and the display device further includes repairing conductive film 54 provided to integrally cover first through hole 63 and second through hole 64, so as to electrically connect a portion of the first wiring exposed in first through hole 63 and a portion of the first wiring exposed in second through hole 64.

The display device according to the present embodiment has such a configuration. Therefore, even when break area 41 is present as the defect somewhere in the wiring, an influence of this defect can be eliminated because an electrical path of the first wiring is secured by repairing conductive film 54. According to the present embodiment, the highly reliable display device with a few defects can thus be obtained.

Although repairing conductive film 54 may be formed in accordance with any methods, repairing conductive film 54 is preferably formed by laser CVD processing.

In the display device, the first wiring preferably has at least one break area between first portion 61 and second portion 62. When the break area is present as described above, the repairing procedure actually works well by repairing conductive film 54 and the highly reliable display device with a few defects can be obtained.

First and second through holes 63 and 64 are preferably through holes bored by irradiation with laser light. In the display device having such a configuration, the operation of boring the through holes can be performed by irradiation with laser light, and thus, the through holes can be bored readily and with high accuracy. As a result, the highly reliable display device can be obtained.

In a first aspect of the display device according to the present embodiment, repairing conductive film 54 is preferably provided to have an elongated shape connecting first portion 61 and second portion 62 along wiring 11, which is the first wiring, as shown in FIG. 5. With such a provision, even when one more repairing conductive film is formed at a near position in an other wiring, interference with the repairing conductive film in the other wiring can be avoided. Therefore, such a provision is preferable.

In a second aspect of the display device according to the present embodiment, it is preferable that between first portion 61 and second portion 62, wiring 11, which is the first wiring, has short circuit portion 42 electrically communicating with an other conductive portion, and repairing conductive film 54i is formed to bypass short circuit portion 42, and the first wiring is broken between first portion 61 and short circuit portion 42 as well as between second portion 62 and short circuit portion 42, as shown in FIG. 12. In the example shown in FIG. 12, these breaks are implemented by break portions 65 and 66. With such a configuration, the short circuit portion is electrically isolated by the breaks on both sides, and thus, an influence of the short circuit portion can be eliminated. In addition, since the repairing conductive film is formed to bypass the short circuit portion and the electrical path is secured, the function of the first wiring can be maintained.

In each of the aforementioned embodiments, description has been given on the assumption that at least a part of the plurality of wirings provided to extend in parallel to one another in the same layer in one gap region are the source wirings. These “plurality of wirings” are not, however, limited to the wirings extending in the direction of the source wiring. The present invention is also applicable to “plurality of wirings” extending in the direction of the gate wiring. In this case, a part or all of “plurality of wirings” may be the gate wirings. However, when the present invention is applied to the plurality of wirings extending in the direction of the gate wiring, an insulating layer and a layer of a repairing conductive film need to be newly added. On the other hand, when the present invention is applied to the plurality of wirings extending in the direction of the source wiring, an insulating layer and a layer of a repairing conductive film do not need to be newly added, and thus, increase in the number of steps and increase in cost can be avoided. Therefore, when the present invention is applied, application to the plurality of wirings extending in the direction of the source wiring is optimum.

It should be understood that the embodiments disclosed herein are illustrative and not limitative in any respect. The scope of the present invention is defined by the terms of the claims, rather than the description above, and is intended to include any modifications within the scope and meaning equivalent to the terms of the claims.

### INDUSTRIAL APPLICABILITY

The present invention can be employed in a method for correcting a defect in a display device, a display device and a method for manufacturing the display device.

### REFERENCE SIGNS LIST

10, 10j gap region; 11, 12, 13, 14, 21 wiring; 31a, 31b, 31c, 31d picture element electrode; 41, 41a, 41b break area; 42 short circuit portion; 43 foreign substance; 51 substrate; 52 lower insulating layer; 53 upper insulating layer; 54, 54i, 54j, 54k, 54n repairing conductive film; 55 protective insulating layer; 61, 61a, 61b first portion; 62, 62a, 62b second portion; 63 first through hole; 64 second through hole; 65, 66 break portion

1. A method for correcting a defect of a first wiring of a plurality of wirings in a display device, the display device comprising:
a substrate having a plurality of picture element electrodes arranged in a plane;
a plurality of wirings extending in parallel to one another in a same layer in one gap region sandwiched between two adjacent picture element electrodes of said plurality of picture element electrodes; and
an upper insulating layer provided to cover said plurality of wirings,
the method including the steps of:
boring a first through hole and a second through hole in said upper insulating layer so as to expose said first wiring in a first portion and a second portion located to sandwich an area of said defect of said first wiring, respectively; and
forming a repairing conductive film integrally covering said first portion and said second portion, so as to electrically connect a portion of said first wiring exposed in said first through hole and a portion of said first wiring exposed in said second through hole.

2. The method for correcting a defect in a display device according to claim 1, wherein
said first wiring has at least one break area between said first portion and said second portion.

3. The method for correcting a defect in a display device according to claim 1, wherein
said step of boring a first through hole and a second through hole is performed by irradiation with laser light toward said first portion and said second portion.

4. The method for correcting a defect in a display device according to claim 1, wherein
said repairing conductive film is provided to have an elongated shape connecting said first through hole and said second through hole along said first wiring.

5. The method for correcting a defect in a display device according to claim 1, wherein
between said first portion and said second portion, said first wiring has a short circuit portion electrically communicating with an other conductive portion, in said step of forming a repairing conductive film, said repairing conductive film is formed to bypass said short circuit portion, and
after said step of forming a repairing conductive film, the method includes a step of breaking said first wiring between said first portion and said short circuit portion as well as between said second portion and said short circuit portion.

6. The method for correcting a defect in a display device according to claim 1, wherein
after said step of forming a repairing conductive film, the method includes a step of adjusting a planar outer shape of said repairing conductive film by removing an unnecessary portion of said repairing conductive film by irradiation with laser light.

7. A method for manufacturing a display device, comprising the steps of:
forming a plurality of picture element electrodes arranged in a plane, on a substrate;
forming a plurality of wirings extending in parallel to one another in a same layer in one gap region sandwiched between two adjacent picture element electrodes of said plurality of picture element electrodes;
forming an upper insulating layer to cover said plurality of wirings; and
performing the method for correcting a defect in a display device according to claim 1.

8. A display device, comprising:
a substrate having a plurality of picture element electrodes arranged in a plane;
a plurality of wirings extending in parallel to one another in a same layer in one gap region sandwiched between two adjacent picture element electrodes of said plurality of picture element electrodes; and
an upper insulating layer provided to cover said plurality of wirings, a first through hole and a second through hole being bored in said upper insulating layer so as to expose a first wiring in a first portion and a second portion of said first wiring of said plurality of wirings, respectively,
the display device further comprising
a repairing conductive film provided to integrally cover said first through hole and said second through hole, so as to electrically connect a portion of said first wiring exposed in said first through hole and a portion of said first wiring exposed in said second through hole.

9. The display device according to claim 8, wherein
said first wiring has at least one break area between said first portion and said second portion.

10. The display device according to claim 8, wherein
said first through hole and said second through hole are through holes bored by irradiation with laser light.

11. The display device according to any one of claim 8, wherein
said repairing conductive film is provided to have an elongated shape connecting said first portion and said second portion along said first wiring.

12. The display device according to claim 8, wherein
between said first portion and said second portion, said first wiring has a short circuit portion electrically communicating with an other conductive portion,
said repairing conductive film is formed to bypass said short circuit portion, and
said first wiring is broken between said first portion and said short circuit portion as well as between said second portion and said short circuit portion.
